(19) United States
(12) Patent Application Publication
(10) Pub. No.: US 2009/0010723 A1
(43) Pub. Date: Jan. 8, 2009

(54) Method and Tool for the Precision Cutting of Workpieces with Small Corner Radii and Greatly Reduced Draw-In in a One-Stage Arrangement

(76) Inventor: Willi Grimm, Kallnach (CH)

Correspondence Address: JORDAN AND HAMBURG LLP, 122 EAST 42ND STREET, SUITE 4000, NEW YORK, NY, 10168, US

(21) Appl. No.: 12/223,570

(22) PCT Filed: Feb. 2, 2007
(86) PCT No.: PCT/EP2007/001106

§ 371 Date: Aug. 4, 2008

(30) Foreign Application Priority Data
Feb. 3, 2006 (EP) 06090018.0

(51) Int. Cl. B26D 1/00; B21D 28/00

(52) U.S. Cl. 407/116; 72/334

(57) ABSTRACT

The invention relates to a method and a tool for producing workpieces with small corner radii in relation to the cutting thickness and with greatly reduced draw-in by precision cutting in a precision cutting tool (3) of a precision cutting machine, in which method the workpiece is clamped between two tool parts consisting of a respective top and bottom cutting die and of a top (10) and a bottom cutting punch (20), and the cutting is effected in interaction with the top (10) and the bottom cutting punch (20). The object of the invention is to improve a method and a tool for producing workpieces in such a way that the precision cutting can also be applied to parts with small corner radii and sharp-edged corners at a greater sheet thickness without restricting the functioning of the parts and while simultaneously ensuring economical advantages. This object is achieved by the workpiece being machined in a one-stage arrangement in at least two successive cutting sequences (A, B) in different cutting directions with the following partial steps: A) cutting out a semifinished product, matched to the workpiece geometry, in a first cutting operation in a vertical working direction with slight draw-in, B) finish cutting of the semifinished product, produced according to step (A), in at least one further cutting operation in a working direction opposed to step (A), wherein the draw-in of partial step (A) is filled again at least in the corner region.

The invention relates to a method for manufacturing workpieces with small corner radii in relation to the thickness to be cut and greatly reduced edge reduction in a fine blanking tool of a fine blanking machine, wherein the workpiece is clamped between two tool parts respectively consisting of an upper and a lower cutting die as well as of an upper and a lower cutting punch and the cutting is realized by the combined efforts of upper and lower cutting punches.

The invention further relates to a tool for fine blanking of workpieces with small corner radii in relation to the thickness to be cut and greatly reduced edge reduction from a cutting strip, a sheet a coil material or the like with two clamping the latter tool halves respectively consisting of at least one cutting die and one cutting punch.

### STATE OF THE ART

The limitations of fine blanking of portions with small corner radii in relation to the thickness of the sheet to be cut and to the quality of the material are sufficiently known. Based on experience a fine blanking severity is defined which distinguishes the severity degrees S1 (easy), S2 (medium) and S3 (difficult) (see “Umformen und Feinschneiden”, in Handbuch für Verfahren, Werkstoffe, Teilegestaltung, pages 154 to 165, Verlag Hallwag AG, 1997, Switzerland). Thus the severity degree is essentially defined by the cutting path geometry and the thickness of the metal sheet. For this the cutting path geometry is divided into simple geometric basic areas such as corner radii, hole diameters, groove and fin widths. From the ratio between a geometric dimension and the thickness of the metal sheet results the severity degree of fine blanking, which grows with growing metal sheet thickness. That means that fine blanking of large-area thin parts is easier than fine blanking of narrow fins or rings with big sheet thickness. Also obtuse-angled corners with big radii are to be cut better than sharp-cornered with small radii.

From DE 39 31 320 C1 is known a method for manufacturing burr-free workpieces by punch counter cutting, for instance in an fine blanking tool, wherein a cutting strip from which the workpiece is to be cut is clamped between to tool parts respectively consisting of an upper and a lower cutting die as well as of an upper and a lower cutting punch and the cutting is realized by the combined efforts of upper and lower cutting punches, wherein the workpiece is started to be cut along a cutting line and then cut out in the opposite direction.

This state of the art exactly shows the intended reduction on both sides as a result of counter cutting.

Typical characteristics of fine blanking parts are edge reduction and burr. Especially at corner portions edge reduction occurs, which is growing with corner radii becoming smaller and growing sheet thickness. The reduction depth may be around 20% and the reduction width may be 30% of the sheet thickness or more (see DIN 3345, Feinschneiden, August 1980). Thus this reduction depends on the thickness and quality of the material, so that controlling it is possible only in a limited way and often results in limited functioning of parts, for example because of lack of sharp-edged tips of interlocking parts or because of the caused change in the functional length of parts.

### OBJECTION

At this state of the art the invention has the objection to improve a method and a tool for manufacturing workpieces in such a way that fine blanking can be also applied for parts with small corner radii and sharp-edged corners with greater sheet thickness without limiting the function of the parts and at the same time giving economic advantages.

This objection is solved by a method of the kind mentioned above with the characterizing elements of claim 1 and by a tool with the characterizing elements of claim 5.

Advantageous aspects of the method and the tool can be learned from the subclaims.

The solution according to this invention is characterized in that fine blanking becomes economically applicable also for portions of parts with small corner radii and sharp edge portions, for example interlocking parts with greater thickness. It is based on the principle of different cutting directions of the geometries of parts converging without corner radius.

Thus the part to be cut at least consists of two cutting geometries, for example a circular geometry and a toothed geometry, wherein the process of fine blanking is executed in a one-stage arrangement. In a first partial step the addendum circle structure of the interlocking part is cut out of the cutting strip in vertical working direction. It follows the cutting out of the blank spaces between the teeth in a working direction opposite to the first partial step.

The special advantage of the method according to this invention is that the converging tool geometries are not pressure loaded at the same time and not in the same direction. The pressure loads in the corner area of the workpieces thus can be significantly decreased, so that complex part geometries also of greater thickness can be fabricated by fine blanking with sharp edges, massively reduced rollover and precise functional length.

Because of the specifically selected cutting geometry of the first partial step it is contrived that the rollover is filled up again during the second partial step.

The method and tool according to this invention only require a one-stage arrangement and further makes it possible to minimize the application of multi-step fabrication processes, whereby the fine blanking process becomes more efficient also in case of parts with complex structure and greater thickness.

Further advantages and details accrue from the following description with reference to the attached figures.

### EMBODIMENT

In the following the invention will be explained in more detail at the example of an embodiment.

It is shown in

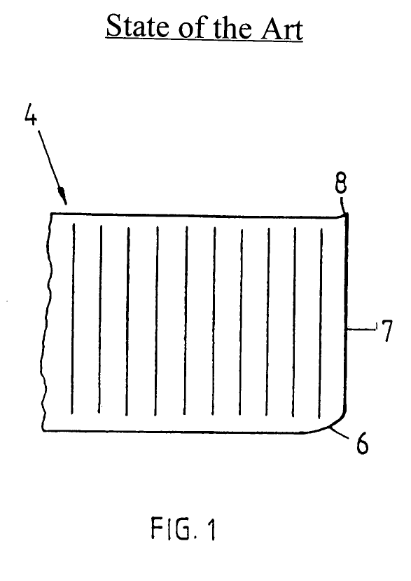

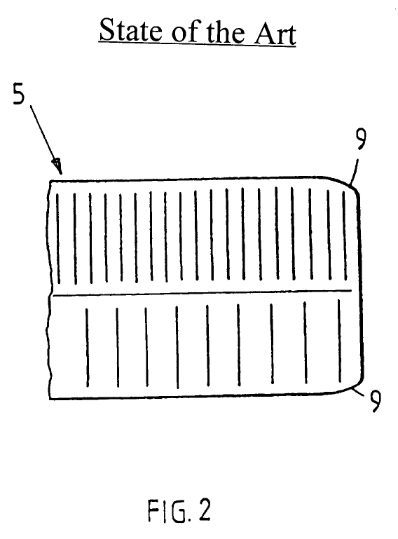

FIGS. 1 and 2 a partially illustrated cross-section of fine blanked parts according to the state of art of DE 39 31 320 C1,

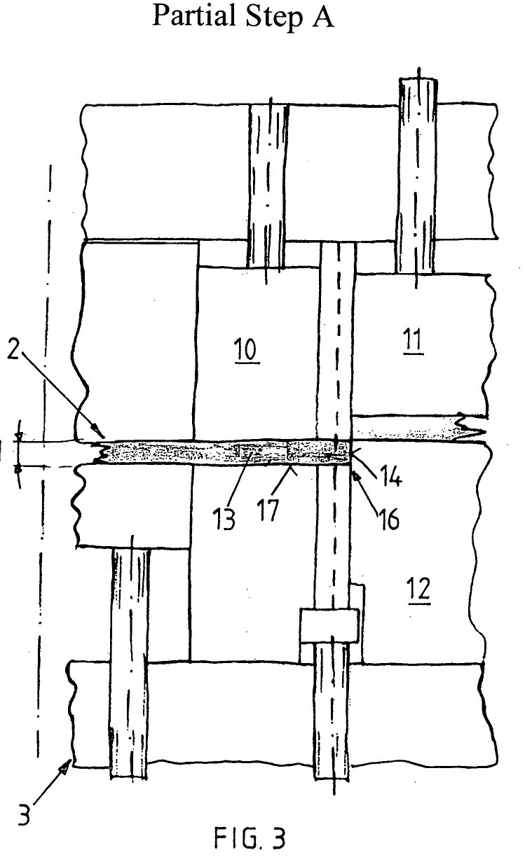

FIG. 3 a simplified schematic view of the tool according to the invention during the execution of the first partial step of the method according to the invention,

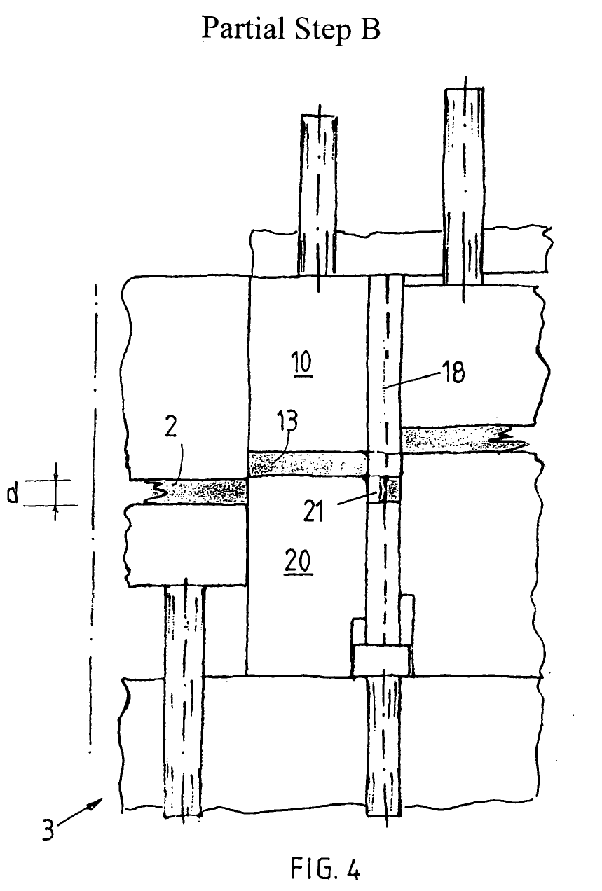

FIG. 4 another simplified view of the method according to the invention during the execution of the second partial step of the method according to the invention,

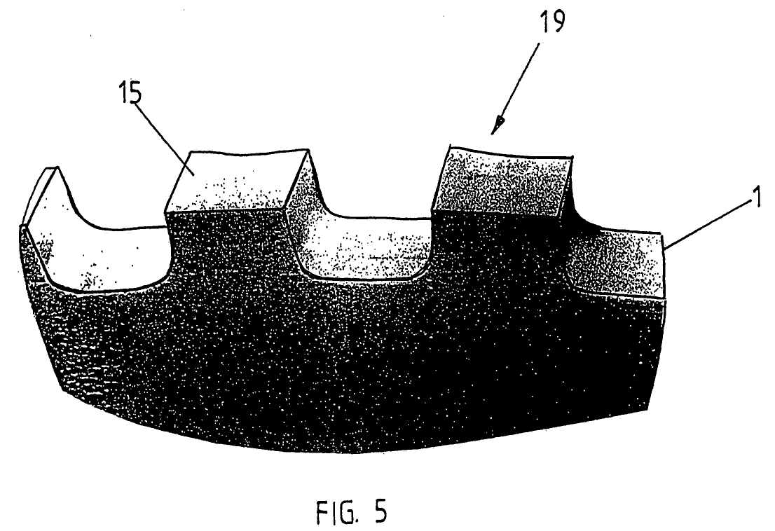

FIG. 5 the section of the cutting area geometry of an interlocking part produced according to the method of this invention as enlarged perspective view.

With the method according to the invention shall be fabricated a workpiece 1, in this case an interlocking part of greater thickness d, for instance 6.5 mm, by fine blanking it out of a cutting strip 2. The principle layout of the fine blanking tool 3 corresponds to the known state of the art. Thus a detailed description can be omitted. That is why in the following will be emphasized only the special features of the tool.

The FIGS. 1 and 2 show the cutting geometry of a fine blanked and a counter fine blanked part 4 and 5, respectively, which is known from the state of the art according to DE 39 31 320 C1. The fine blanked part 4 has an edge reduction 6, a burnish 7 and a burr 8, wherein the latter occurs on the side opposite to the edge reduction 6. From the cutting geometry of the counter fine blanked part 5 can be seen, that during counter fine blanking occurs an edge reduction 9 on both sides, for which reason parts with sharp edges, like for example interlocking parts, can not be fabricated with the necessary dimensional accuracy.

The single-step fine blanking tool 3 has—as shown in FIGS. 3, 4 and 5—a multi-step main punch 10. The strip material 2 to be cut is clamped between a blank holder 11 and a blanking die 12. It has a thickness d, in this case 6.5 mm. The main punch 10, the geometry of which respectively corresponds to the interlocking part 1 to be fabricated, in a first partial step A in vertical working direction cuts a blank 13 (semi-finished product) with a addendum circle 14 corresponding to the subsequent toothing 15 out of the strip material 2. The rollover 16 at the addendum circle 14 of blank 13 is negligible small and lies on side 17 of blank 13, which faces the applying main punch 10.

In the following partial step B (see FIG. 4) the punches 18 (punches for cutting out the blanks between the teeth) for the final cut of the interlocking part 1 in the opposite direction to partial step A after a working distance corresponding to the thickness d of the strip material 2 are cutting the teeth geometries 19 out of the blank 13 running back with the die-plate 20, whereby the resulting waste portions 21 are also removed.

The corner portion of the rollover 16 from partial step A is filled up again.

The cutting punch of the fine blanking tool 3 is designed as a multi-part main punch 10 for cutting out a first cutting geometry, for example of a blank 13. The diameter of the blank 13 corresponds to the diameter of the addendum circle of the toothing 15 of the interlocking part 1 to be fabricated. The working direction of the main punch 10 extends vertically. The main punch 10 is allocated at least one punch 18 (punch for cutting out the blanks between the teeth) for the final cut of the semi-finished product to receive the interlocking part 1. The punch 18 works in the opposite direction to the main punch 10 and with respect to the first cutting geometry it is arranged in a way that it can be applied to it without applying the pressure load in the same direction.

In the case of fabrication an interlocking part 1 the cutting geometry of the main punch 10 is an addendum circle. But it also can be a geometry consisting of a complex contour of steady or unsteady curves, if other parts with other complex shapes are to be fine blanked.

The punches 18 for the final cut advantageously have geometries of a contour with steady or unsteady curves.

Thereby the cutting geometries of main punch 10 and punch 18 can be varied, so that complex parts can be composed of simple geometries, respectively.

The fine blanking tool 3 has a single-step structure. It facilitates contradirectional and directly adjoining cutting operations described above as partial steps A and B.

Thus the converging tool geometries of main punch 10 and punch for cutting out the blanks between the teeth 18 are not subjected to pressure load at the same time and also not in the same direction, so that the otherwise necessary corner radius to reduce the partial compression tensions in the tip portions of the interlocking part can be dropped. FIG. 5 shows as an example an interlocking part fabricated according to the method of the invention.

Thus it is possible to produce complex workpieces or parts of greater thickness with sharp edges and massively reduced rollover in a economically efficient way also by fine blanking.

### LIST OF REFERENCE SIGNS

Interlocking part, work piece 1
Strip material 2
Fine blanking tool 3
Cross section of a part produced by fine
blanking according to the state of the art 4
Cross section of a part produced by counter
fine blanking according to the state of the art 5
Edge reduction 6
Burnish 7
Burr 8
Rollover on both sides 9
Main punch 10
Blank holder 11
Cutting die 12
Blank (semi-finished product) 13
Addendum circle of 15 14
Toothing 15
Rollover of 13 16
Side of 13 17
Punch (for cutting out blanks between teeth) 18
Tooth geometry 19
Die-plate 20
Waste portion 21
Thickness of 2 d
Partial step A
Partial step B

1. Method for manufacturing workpieces with small corner radii in relation to the thickness to be cut and greatly reduced edge reduction by fine blanking in a fine blanking tool of a fine blanking machine, wherein the workpiece is clamped between two tool parts respectively consisting of an upper and a lower cutting die as well as of an upper and a lower cutting punch and the cutting is realized by the combined efforts of upper and lower cutting punches, characterized in that the workpiece is shaped in a one-stage arrangement in at least two chronologically successive cutting steps (A,B) in different cutting directions comprising the following partial steps:
A) Cutting out a semi-finished product corresponding to the geometry of the workpiece in a first cutting process in vertical working direction with small rollover,
B) Final cutting of the semi-finished product fabricated according to step (A) in at least one further cutting process in a working direction opposite to that of step (A), wherein the rollover of the partial step (A) at least in the corner area is filled up again.

2. Method according to claim 1, characterized in that the converging tool geometries (cutting punches) for the partial steps (A) and (B) are not pressure loaded at the same time and not in the same direction.

3. Method according to claims 1 or 2, characterized in that the tool geometries for the partial steps (A) and (B) are partitioned in a way that the pressure loads are reduced in the corner area of the workpiece.

4. Method according to claims 1 or 2, characterized in that the cutting geometry of partial step (A) is adjusted to the cutting geometry of partial step (B) in a way that the rollover of partial step (A) in the corner area is filled up and the workpiece does not loose functional length.

5. Tool for fine blanking of workpieces with small corner radii in relation to the thickness to be cut and greatly reduced edge reduction from a cutting strip, a sheet a coil material or the like with two clamping the latter tool halves respectively consisting of at least one cutting die and one cutting punch, characterized in that the cutting punch is designed as a multi-part main punch (10) designated to cut out a first cutting geometry of a semi-finished product (13), which is allocated at least one punch (18) for the final cut of the semi-finished product acting in vertical working direction with respect to the main punch, wherein the punch (18) is arranged with respect to the first cutting geometry in a way that it can be applied to it without applying the pressure load in the same direction.

6. Tool according to claim 5, characterized in that the cutting geometries of the main punches (10) are such as an addendum circle, a contour with a steady or unsteady curve, a straight line or an assembled straight line.

7. Tool according to claim 5, characterized in that the cutting geometries of the punches (18) for final cutting are such as a contour with a steady or unsteady curve, a straight line or an assembled straight line.

8. Tool according to any of claims 5 to 7, characterized in that the main punch (10) and the punch (18) for the final cut are not exposed to pressure at the same time and not in the same direction.

9. Tool according to claim 7, characterized in that the tool geometries of main punch (10) and punch (18) for final cutting are adjusted in a way that the pressure load in the corner area of the fine blanked workpiece is massively reduced.

10. Tool according to claim 7, characterized in that the cutting geometries of main punch (10) and punch (18) for final cutting are adjusted in a way that a rollover in the corner area of the workpiece is filled up again and the workpiece does not loose functional length.

11. Tool according to claim 1, characterized in that it has a single-step setup.

12. Tool according to claims 1 or 11, characterized in that the single-step setup facilitates contradirectional and directly adjoining cutting operations (A,B).
